(19) United States
(12) Patent Application Publication
(10) Pub. No.: US 2023/0001384 A1
(43) Pub. Date: Jan. 5, 2023

(54) Alumina Bismuth Catalyst Support and Method for Its Production

(71) Applicant: Sasol Germany GmbH, Hamburg (DE)

(72) Inventors: Thomas Harmening, Munster (DE); Marcos Schoneborn, Hamburg (DE); Ann-Kathrin Jager, Brunsbuttel (DE)

(21) Appl. No.: 17/778,742

(22) PCT Filed: Nov. 30, 2020
(86) PCT No.: PCT/EP2020/083968

§ 371 Date: May 20, 2022

(30) Foreign Application Priority Data
Nov. 29, 2019 (EP) 19212712.4

(51) Int. Cl. B01J 23/18; B01J 21/12; B01J 35/10; B01J 37/00; B01J 37/02; B01J 37/08; B01J 6/00

(52) U.S. Cl. CPC B01J 23/18; B01J 21/12; B01J 35/1014; B01J 35/1019; B01J 35/1038; B01J 35/1042; B01J 37/0045; B01J 37/0203; B01J 37/088; B01J 6/001

(57) ABSTRACT

The invention provides for a method to prepare an alumina catalyst support comprising bismuth for emission control applications, to an alumina catalyst support prepared according to the method of the invention and to an alumina catalyst support comprising bismuth and having a specific crystallinity value that leads to improved technical effects.

### FIELD OF THE INVENTION

The invention relates to a method to prepare an alumina bismuth catalyst support for emission control applications, to an alumina bismuth catalyst support prepared according to the method of the invention and to an alumina bismuth catalyst support having specific characteristics.

### BACKGROUND OF THE INVENTION

The main raw emission pollutants in exhaust gases are CO, NOx, unburned hydrocarbons and soot particles. Catalyst systems, including various components and precious metals, for application in emission control are known in the art. Usually a so-called Diesel Oxidation Catalyst (DOC) containing precious metals supported on high-surface area refractory oxides such as alumina or silica-alumina converts CO into CO₂ and the unburned hydrocarbons into CO₂ and water. Due to continuously stricter legislation regarding tailpipe emissions and the introduction of more realistic driving cycles, including RDE (Real Driving Emissions) and WLTP (Worldwide Harmonized Light Vehicle Test Procedure), the low temperature activity of such catalyst systems has become an important field of development.

The incorporation of activating and/or stabilizing additives (for example metal oxides) to the catalyst or catalyst support materials respectively is a well-known approach. WO 2017/064498 A1 and U.S. Pat. No. 7,611,680 B2 disclose the beneficial effect of low temperature conversion for CO and hydrocarbons by the addition of Bi₂O₃ to a catalyst. In U.S. Pat. No. 7,611,680 it is described that the bismuth is added as a promoter by an in situ reduction process. In WO 2017/064498 A1 the bismuth is supported on a support.

The prior art therefore teaches the incorporation of the Bi₂O₃ as a separate crystalline phase. This leads to low specific surface area of the promoting additive and therefore to limited beneficial interaction with the active precious metal.

The object of the present invention is therefore to provide an improved alumina bismuth support applicable in emission control catalysis having improved characteristics and a novel method for preparation of same.

### DESCRIPTION OF THE INVENTION

According to a first aspect of the invention there is provided a method to prepare an alumina bismuth catalyst support, the method comprising the steps of:
i) providing an aluminum containing composition, wherein the aluminum containing composition comprises a) boehmite or b) silica containing aluminum oxide;
ii) providing a bismuth aqueous solution, the bismuth aqueous solution comprising a bismuth salt and a base comprising nitrogen, preferably ammonia, and having a pH value of between 4 and 9;
iii) contacting the aluminum containing composition with the bismuth aqueous solution to form an aluminum bismuth intermediate; wherein the contacting is carried out:
   in case of process step i) involving the aluminum containing composition comprising boehmite by mixing the aluminum containing composition in dried powder form or in the form of a suspension with the bismuth aqueous solution to form an aluminum bismuth intermediate, or
   in case of process step i) involving the aluminum containing composition comprising silica containing aluminum oxide by impregnating the aluminum containing composition in dried powder form with the bismuth aqueous solution to form an aluminum bismuth intermediate, and
iv) calcining the aluminum bismuth intermediate to form an alumina bismuth catalyst support.

In step iii) the aluminum bismuth intermediate may also be called a boehmite bismuth intermediate in case in step i) the aluminum containing composition comprised boehmite.

In step iii) the aluminum bismuth intermediate may also be called a silica aluminum oxide bismuth intermediate in case in step i) the aluminum containing composition comprised silica.

Preferably the aluminum containing composition consists of boehmite or consists of silica containing aluminum oxide with respect to the aluminum containing compounds in the composition. The aluminum containing composition may for example (beside silica or other components) additionally comprise one or more dopants.

The aluminum oxide in the silica containing aluminum oxide preferably is or comprises transitional alumina. The silica containing aluminum oxide more preferably comprises transitional alumina, silica and one or more dopant. The transitional alumina is one or more of gamma (γ), delta (δ) or theta (θ) aluminum oxide, and preferably is or comprises gamma alumina.

According to one embodiment, the aluminum containing composition preferably comprises at least 50 wt.-% silica containing aluminum oxide.

According to a further embodiment, the aluminum containing composition preferably comprises at least 50 wt. % boehmite. Preferably the aluminum containing composition contains boehmite (AlOOH) with or without one or more dopants and even more preferably the aluminum containing composition contains boehmite, silica and one or more dopants.

When silica is present in the aluminum containing composition the SiO₂ content is between 1 and 40 wt.-%, preferably between 1 and 20 wt.-%, based on the total dry mass of SiO₂, aluminum oxide, aluminum oxide hydroxide and aluminum trihydroxide. Preferably the aluminum containing composition does not additionally comprise aluminum trihydroxide, but only aluminum oxide or aluminum oxide hydroxide.

Boehmite includes boehmite as such and pseudo-boehmite. The boehmite may be defined as any alumina having the molecular formula AlOOH*xH₂O, where x is between 0 and 0.5. Aluminum oxide hydroxide is the same as boehmite. Alumina is understood to mean aluminum oxide and/or aluminum oxide hydroxide. Aluminum oxide is Al₂O₃.

The dopants may be oxides of or water-soluble salts of alkaline earth metals, transition metals, for example Zr, Ti, rare-earth elements or mixtures thereof. Preferably their content is between 0 and 10 wt.-%, more preferably between 0 and 5 wt.-%, calculated as oxides based on the total mass of the aluminum oxide, aluminum oxide hydroxide and aluminum trihydroxide. The transitional metals are preferably Mn, Fe, Cu, Nb, Zr, Ti or mixtures thereof and more preferably Zr, Ti or mixtures thereof. The dopants may also be alkaline earth metal carbonates, in particular barium carbonate.

The aluminum containing composition may be provided in dried powder form or in the form of an aluminum suspension. If the aluminum containing composition is in the form of an aluminum suspension, the suspension comprises the aluminum containing composition and at least water, preferably in a weight ratio of 2:98 to 20:80. The aluminum suspension may further include pH modifying additives for example carboxylic acid or ammonia, preferably mono-carboxylic acids such as acetic acid.

The aluminum suspension is preferably a boehmite suspension wherein the boehmite is prepared by hydrolysis of an Al-alkoxide, most preferably involving hydrothermal aging. Hydrothermal ageing is carried out between 100 and 300° C., preferably between 120 and 240° C. for 0.5 hours to 30 hours, preferably between 3 hours and 10 hours; time and temperature are independently selected.

The bismuth aqueous solution preferably comprises a water-soluble Bi³⁺ salt, more preferably a Bi nitrate or a Bi citrate and most preferably a Bi Citrate. The anion of such salts are preferably organic compounds such as an organic acid. The pH value of the bismuth aqueous solution is between 4 and 9, preferably between 6 and 8.

Contacting means either a) mixing the aluminum containing composition, preferably the aluminum suspension, with the bismuth aqueous solution to form the aluminum bismuth intermediate or b) impregnating the aluminum containing composition in dried powder form with the bismuth aqueous solution to form the aluminum bismuth intermediate. In the case the aluminum containing composition is or comprises a silica containing aluminum oxide step iii) is with “impregnation” and in case the aluminum containing composition is or comprises boehmite step iii) is with “mixing”.

Impregnation of the aluminum containing composition may be carried out by any impregnation method known in the art, preferably by incipient wetness impregnation. Such a method provides for impregnating between 80 and 100% of the aluminum containing composition with the bismuth aqueous solution. By % is meant the ratio of (volume of liquid added)/(pore volume).

When the aluminum suspension is mixed with the bismuth aqueous solution the method may include the further step of drying, preferably spray drying, the aluminum bismuth intermediate to form a dried aluminum bismuth intermediate that will then be calcined.

The aluminum bismuth intermediate or the dried aluminum bismuth intermediate is calcined at a temperature of between 500 and 1000° C., more preferably between 600 and 900° C., even more preferably at a temperature of between 500 and 700° C., and independent thereof for a period of at least 0.5 hours, preferably between 0.5 and 5 hours, preferably 3 hours.

According to a second aspect of the invention there is provided an alumina bismuth catalyst support prepared according to the method of the invention.

According to a third aspect of the invention, there is provided an alumina bismuth catalyst support comprising:
i) at least 80 wt.-% of a transition alumina based material; and
ii) between 1 and 20 wt.-% of a bismuth oxide, characterized by a crystallinity value C_{Bi} below 10, preferably a crystallinity value C_{Bi} of less than 3.

The transition alumina based material preferably is or may comprise aluminum oxide, silica and/or dopants. More preferably the transition alumina based material comprises aluminum oxide, silica and one or more dopants.

The transition alumina based material preferably comprises Gamma, Delta or Theta aluminum oxides, or mixtures thereof.

The transition alumina based material preferably comprises at least 50 wt.-% of aluminum oxides

When silica is present in the aluminum containing composition the SiO₂ content is between 1 and 40 wt.-%, preferably between 1 and 20 wt.-%, based on the oxide mass of silica and the aluminum oxide

The dopants may be oxides of or alkaline earth metals of transition metals, for example Zr, Ti, rare-earth metals or mixtures thereof. Preferably their content is between 0 and 10 wt.-%, preferably between 0 and 5 wt.-%, calculated as oxides based on the total mass of the aluminum oxide, silica and the dopant. The transitional metals are preferably Mn, Fe, Cu, Nb, Zr, Ti or mixtures thereof and more preferably Zr, Ti or mixtures thereof.

The alumina bismuth catalyst support comprises a BET specific surface area between 50 and 300 m²/g, preferably between 100 and 200 m²/g. The alumina bismuth catalyst support comprises a pore volume of between 0.1 and 1.5 ml/g, preferably between 0.5 and 1.0 ml/g.

According to the invention an improved heterogeneous catalysts is obtained with improved contact between the active phase (noble metals) and the promotor. This is achieved by a homogeneous dispersion of the promotor bismuth oxide in the support material matrix leading to good accessibility of the promotor by the noble metals and uniform promotor-noble metal arrangements throughout the entire catalyst. The virtually X-ray amorphous state of the bismuth oxide is indicative for such a homogeneous dispersion in the matrix of the alumina based material.

The bismuth oxide is homogenously dispersed in the matrix of the alumina based material. Without being bound by theory the Applicant believes that a homogenous dispersion of the bismuth oxide small crystals in a virtually X-ray amorphous state leads to the beneficial properties of the composite. The X-ray amorphous state may be described by the crystallinity value as given below.

The crystallinity value as used herein is determined in accordance with the following method. The X-ray diffraction (XRD) pattern of Bi₂O₃ using Cu K alpha radiation comprises the strongest reflex around 2θ=28° (021 reflex in space group P4-21c). The XRD pattern of a transition based alumina material comprises a strong reflex around 2θ=67°. The normalized intensity ratio of these two reflections (see equation 1) is a measure for the crystallinity of bismuth oxide C_{Bi} on the transition alumina based material

C_{Bi}=[(I₂₈−I₂₄)/(I₆₇−I₇₂)]/m_{Bi} (equation 1)
I₂₈: Intensity of the reflex around 28°
I₂₄: Intensity of baseline near the reflex around 24°
I₆₇: Intensity of the reflex around 67°
I₇₂: Intensity of baseline near the reflex around 72°
m_{Bi}: mass of Bi₂O₃/(mass of Bi₂O₃+mass of transition alumina based material

Homogeneity is measured by scanning-electron-microscope (SEM) cross-section imaging, optionally together with EDX (Energy Dispersive X-ray Analysis) element mapping revealing the domain sizes of the transition alumina based material, the bismuth oxide and the alumina bismuth catalyst support.

Surface area and pore volume are measured with N₂ physisorption using typical volumetric devices like the Quadrasorb from Quantachrome at the temperature of liquid nitrogen. The surface area is determined using BET theory (DIN ISO 9277) while the pore volume is determined according to DIN 66131. The pore radius range is between 18 and 1000 Å.

According to a fourth aspect of the invention there is provided use of the alumina bismuth catalyst support as hereinbefore described as a support for an oxidation catalyst, preferably comprising platinum (Pt) and/or palladium (Pd), in particular a diesel oxidation catalyst for vehicle emission control applications.

The invention will now be described with reference to the following non-limiting examples and Figures in which:

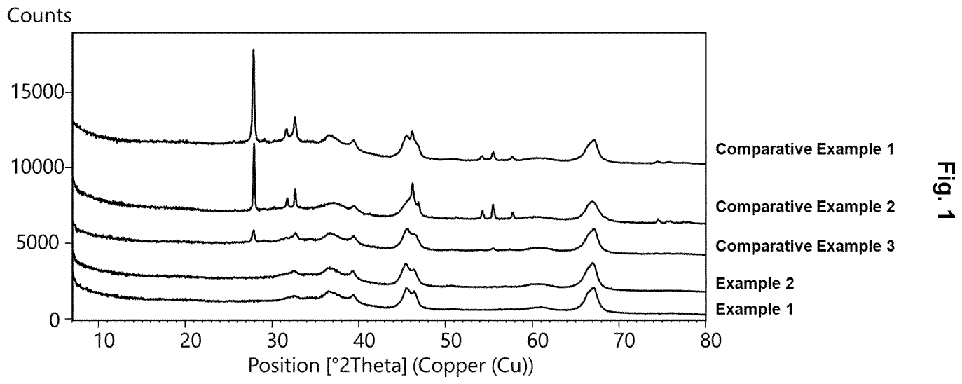

FIG. 1 is a powder XRD of the composition obtained in Example 1 and Example 2 compared to Comparative Examples 1-3 showing the difference in crystallinity of Bi₂O₃; and

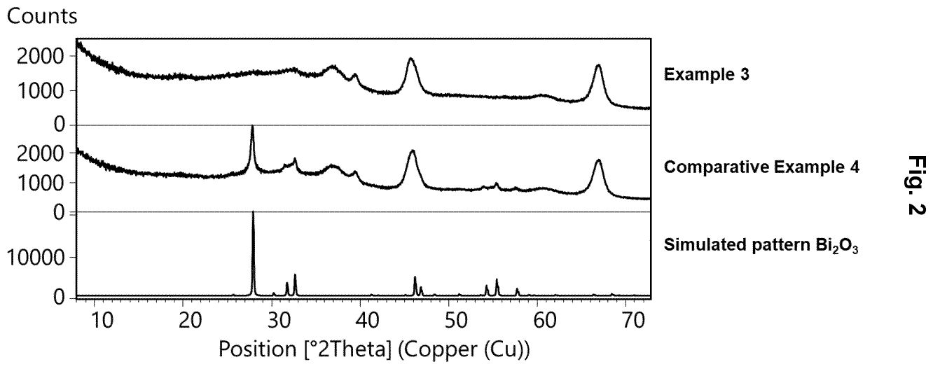

FIG. 2 is a powder XRD of the composition obtained in Example 3 compared to Comparative Example 4, together with a simulated XRD pattern of Bi₂O₃ showing the difference in crystallinity of Bi₂O₃.

### EXAMPLES

### Example 1 (Aluminum Containing Composition Comprising Boehmite and Silica)

A bismuth oxide doped silica-alumina with 3 wt.-% Bi₂O₃ was prepared according to the present invention.

A Bi-Citrate solution was prepared by adding 516 g Bi-Citrate to 1.7 kg H₂O. 190 g of a 25 wt.-% NH₃ solution was added to obtain a clear solution with pH 7. The Bi-Citrate solution was added to an alumina suspension containing boehmite and silica in a 95:5 weight ratio calculated as per the oxides (SIRAL 5). The mixture was spray dried and calcined at 950° C. for 3 h.

### Example 2 (Aluminum Containing Composition Comprising Silica Containing Aluminum Oxide)

A bismuth oxide doped silica-alumina with 3 wt.-% Bi₂O₃ was prepared according to the present invention.

A Bi-Citrate solution was prepared by adding 12.2 g Bi-Citrate to 148 g H₂O. 4.1 g of a 25 wt.-% NH₃ solution was added to obtain a clear solution with pH 7. The Bi-Citrate solution was impregnated by incipient wetness impregnation on 234 g of a silica-alumina, SIRALOX 5, containing 5 wt.-% SiO₂ (in dried powder form). The product was calcined at 550° C. for 3 h.

### Comparative Example 1

A bismuth oxide doped silica-alumina with 3 wt.-% Bi₂O₃ was prepared according to U.S. Pat. No. 7,611,680 B2 Example 2.

A solution of 1 g Bi-Citrate in 7.7 g water with a pH value of 2.8 was prepared. This solution was intensively mixed for 15 minutes with 19.7 g of a silica-alumina, SIRAL 5, containing 5 wt.-% SiO₂, dried at 120° C., ground into a fine powder and calcined at 500° C. for 2 h.

### Comparative Example 2

A bismuth oxide doped lanthanum doped alumina with 4 wt.-% Bi₂O₃ was prepared according to U.S. Pat. No. 7,611,680 B2 Example 3.

To 2 g of a La doped alumina was added a solution of 0.111 g Bi-acetate in 4 ml H₂O and 1 ml glacial acetic acid. The resulting paste was mechanically mixed at room temperature for 60 minutes, dried at 130° C. for 2.5 h, ground into a fine powder, and calcined at 500° C. for 1 h. The material contained 3 wt. % La₂O₃.

### Comparative Example 3

A bismuth oxide doped silica-alumina with 3 wt.-% Bi₂O₃ was prepared according to WO 2017/064498 Example 3.

An aqueous suspension of 40 g silica-alumina containing 5 wt.-% SiO₂ was wet-milled to a d90 of 19 μm. Then a solution of 2.1 g bismuth-nitrate in diluted nitric acid was added. The mixture was spray dried and calcined at 500° C.

### Example 3 (Aluminum Containing Composition Comprising Silica Containing Aluminum Oxide)

A Bi-Citrate solution was prepared by adding 3.7 g Bi-Citrate to 16, 1 g H₂O. 1.2 g of a 25 wt.-% NH₃ solution was added to obtain a clear solution with pH 7.

The Bi-Citrate solution was impregnated on 18 g of a dried powder of silica-alumina, SIRALOX 5, containing 5 wt.-% SiO₂. The product was calcined at 550° C. for 3 h.

### Comparative Example 4

A bismuth oxide doped silica-alumina with 10 wt.-% Bi₂O₃ was prepared according to WO 2017/064498 Example 15.

3.88 g Bi-nitrate pentahydrate were dissolved in 2M nitric acid and impregnated on 18 g of a silica-alumina containing 5 wt.-% SiO₂. The product was dried at 105° C. and calcined at 500° C.

The results are summarized in FIGS. 1 and 2 and Table 1. The compositions prepared according to the present invention are characterized by substantially smaller crystallinity values regarding the Bi₂O₃ when compared to the compositions prepared according to the prior art.

TABLE 1

| | mBi₂O₃ in | Bi₂O₃ crystallinity |
|---|---|---|
| Examples | wt. % | value C_{Bi} |
| Example 1 | 3 | 1 |
| Example 2 | 3 | 1 |
| Comparative Example 1 | 3 | 130 |
| Comparative Example 2 | 4 | 108 |
| Comparative Example 3 | 3 | 18 |
| Example 3 | 10 | 2 |
| Comparative Example 4 | 10 | 14 |

1. A method to prepare an alumina bismuth catalyst support, the method comprising the steps of:
i) providing an aluminum containing composition, wherein the aluminum containing composition comprises boehmite or a silica containing aluminum oxide;
ii) providing a bismuth aqueous solution, the bismuth aqueous solution comprising a bismuth salt and a base comprising nitrogen and having a pH value of between 4 and 9;
iii) contacting the aluminum containing composition with the bismuth aqueous solution to form an aluminum bismuth intermediate, wherein the contacting is carried out:
in case of process step i) involving the aluminum containing composition comprising boehmite by mixing the aluminum containing composition in dried powder form or in the form of a suspension with the bismuth aqueous solution to form an aluminum bismuth intermediate, or
in case of process step i) involving the aluminum containing composition comprising silica containing aluminum oxide by impregnating the aluminum containing composition in dried powder form with the bismuth aqueous solution to form an aluminum bismuth intermediate; and
iv) calcining the aluminum bismuth intermediate to form an alumina bismuth catalyst support.

2. The method of claim 1, wherein the aluminum containing composition further comprises at least one dopant, wherein the at least one dopant comprises oxides or water soluble salts of alkaline earth metals, transition metals, rare-earth metals or mixtures thereof.

3. The method of claim 1, wherein the aluminum containing composition comprising boehmite further comprises silica.

4. The method of claim 1, wherein where the aluminum containing composition comprises silica, the silica content is between 1 wt.-% and 40 wt. % based on the oxide mass of silica and the aluminum oxide, aluminum oxide hydroxide and/or aluminum trihydroxide.

5. The method of claim 1, wherein the suspension includes the aluminum containing composition and at least water.

6. The method of claim 1, wherein impregnation of the aluminum containing composition comprises incipient wetness impregnation.

7. The method of claim 1, wherein the aluminum oxide in the silica containing aluminum oxide composition is or comprises one or more transition aluminas.

8. The method of claim 1, wherein when the aluminum containing composition comprising boehmite provided in dried powder form or in the form of a suspension is mixed with the bismuth aqueous solution the method comprises the further step of drying the aluminum bismuth intermediate to form a dried aluminum bismuth intermediate that will then be calcined.

9. The method of claim 1, wherein the aluminum bismuth intermediate or the dried aluminum bismuth intermediate is calcined at a temperature of between 500° C. and 1000° C. for a period of at least 0.5 hours.

10. The method of claim 1, wherein the base comprising nitrogen is ammonia.

11. An alumina bismuth catalyst support obtainable according to the method of claim 1.

12. An alumina bismuth catalyst support comprising:
i) at least 80 wt.-% of a transitional alumina based material; and
ii) between 1 wt.-% and 20 wt.-% of a bismuth oxide, characterized by a crystallinity value CBi below 10,
wherein the crystallinity value CBi is determined from X-ray diffraction pattern of the alumina bismuth catalyst support using Cu K alpha radiation and using equation 1
C_{Bi}=[(I₂₈−I₂₄)/(I₆₇−I₇₂)]/m_{Bi} (equation 1)
with
I₂₈: Intensity of the reflex around 28°
I₂₄: Intensity of baseline near the reflex around 24°
I₆₇: Intensity of the reflex around 67°
I₇₂: Intensity of baseline near the reflex around 72°
m_{Bi}: mass of Bi₂O₃/(mass of Bi₂O₃+mass of transition alumina based material”.

13. The alumina bismuth catalyst support of claim 12, wherein the transition alumina based material comprises alumina, and optionally in addition silica and/or dopants.

14. The alumina bismuth catalyst support of claim 11 further characterized by at least one of the following characteristics:
a) a BET specific surface area between 50 and 300 m²/g; and/or
b) a pore volume of between 0.1 and 1.5 ml/g, wherein the pore volume is measured with N₂ physisorption according to DIN 66131.

15. An alumina bismuth catalyst support of claim 12, wherein the alumina bismuth catalyst support is obtainable according to the method comprising the steps of:
i) providing an aluminum containing composition, wherein the aluminum containing composition comprises boehmite or a silica containing aluminum oxide;
ii) providing a bismuth aqueous solution, the bismuth aqueous solution comprising a bismuth salt and a base comprising nitrogen and having a pH value of between 4 and 9;
iii) contacting the aluminum containing composition with the bismuth aqueous solution to form an aluminum bismuth intermediate, wherein the contacting is carried out:
in case of process step i) involving the aluminum containing composition comprising boehmite by mixing the aluminum containing composition in dried powder form or in the form of a suspension with the bismuth aqueous solution to form an aluminum bismuth intermediate, or
in case of process step i) involving the aluminum containing composition comprising silica containing aluminum oxide by impregnating the aluminum containing composition in dried powder form with the bismuth aqueous solution to form an aluminum bismuth intermediate; and
iv) calcining the aluminum bismuth intermediate to form an alumina bismuth catalyst support.

16. (canceled)

17. The alumina bismuth catalyst support of claim 12 further characterized by at least one of the following characteristics:
a) a BET specific surface area between 50 and 300 m²/g; and/or
b) a pore volume of between 0.1 and 1.5 ml/g, wherein the pore volume is measured with N₂ physisorption according to DIN 66131.
